(19) United States
(12) Patent Application Publication
(10) Pub. No.: US 2015/0010359 A1
(43) Pub. Date: Jan. 8, 2015

(54) Advanced Thermal Conductive Heater System for Environmental Remediation and the Destruction of Pollutants

(71) Applicant: Good Earthkeeping Organization, INC, Corona, CA (US)

(72) Inventor: Grant Geckeler, Corona, CA (US)

(21) Appl. No.: 14/379,040

(22) PCT Filed: Feb. 22, 2013
(86) PCT No.: PCT/US13/27331

§ 371 Date: Aug. 15, 2014

Related U.S. Application Data
(60) Provisional application No. 61/602,773, filed on Feb. 24, 2012.

(51) Int. Cl. F23D 14/28; B09C 1/06; F23L 15/04; B09C 1/00; F23D 14/02; F23D 14/84

(52) U.S. Cl. CPC F23D 14/28; F23D 14/02; F23D 14/84; F23L 15/04; B09C 1/005; B09C 1/065
USPC 405/128.85; 431/354; 431/353; 431/215

(57) ABSTRACT

A thermal conductive heating and desorption system is disclosed, which provides superior results to other systems for the removal of pollutants from soil, groundwater and other affected medias using a novel enhanced gas fired recuperative heater and oxidation system. Pollutants in the affected, heated media are partially destroyed by hydrolysis, pyrolysis and/or oxidation processes. Remaining pollutants are extracted from the affected media, and pollutant off gas is then introduced into the heater system where it is both thermally and catalytically oxidized. Heat from combusted fuel and pollutant off gas in the heater system is used to preheat incoming combustion air through a recuperative heat exchanger, enabling significant reductions in fuel usage by the heater system. Combusted fuel and off gas discharged from the heater system may be further treated to achieve specified discharge standards.

### FIELD OF THE INVENTION

This invention is directed to an improved method for the remediation of subsurface soil and/or groundwater containing pollutants. This method may be conducted both in-situ and ex-situ.

### BACKGROUND OF THE INVENTION

Pollutants in soil, groundwater, or other affected media pose a risk to human health. Many pollutants are carcinogenic, having maximum screening levels promulgated by government bodies. Common pollutants include volatile organic compound, semi volatile organic compound, polycyclic aromatic hydrocarbons, pesticides, herbicides, tars, polychlorinated biphenyls, mercury, dioxins, residue of explosives, and heavy hydrocarbons.

Pollutant spills and leakages into the earth due to corroded or defective containers or pipelines is a common pathway for pollutants to enter the soil and/or groundwater. The hydrocarbons. A plethora of techniques have developed in prior art for the remediation soils and groundwater contaminated by pollutants.

Generally, the physical/chemical properties of the pollutant, and the nature of the contaminated media govern the remediation technique selected. Accordingly, if pollutants are reasonably mobile and difficult to degrade (e.g., chlorinated solvents), and the soil is highly permeable, then soil vapor extraction (SVE) techniques, which develop a vacuum gradient in the soil, would prove effective. Semi-volatile pollutants (e.g., Pentachlorophenol) do not readily volatize, so soil vapor extraction is not an effective technique. Alternative techniques have been considered in prior art. Many of the proposed techniques involve the excavation of the contaminated areas and subsequent incineration of the soil (e.g., direct or indirect ex-situ thermal desorption). Such techniques, while effective in decontaminating the affected soil, are cost prohibitive and energy intensive.

Other prior art techniques involve the use of radio frequency energy, conduction heaters or electric heater wells in combination with vapor extraction systems. For example, U.S. Pat. No. 4,670,634 discloses a method for in-situ decontamination of spills and landfills by radio frequency heating. The soil is heated by radio frequency energy to a temperature higher than that promotes dielectric heating. The heating allows elevated temperatures in the range of 100° C. to 400° C. Decontamination of the heated soil may occur in a number of ways, as by pyrolysis, thermally assisted decomposition, distillation, or reaction with a reagent, such as oxygen. However, this method uses radio frequency power that results in non-uniform heating of the soil resulting in cyclical hot and cold spots in the soil. This method also requires burdensome vapor collection and electromagnetic protective barriers at the surface, resulting in high operating expenses.

U.S. Pat. No. 5,190,405 discloses an in situ method for removal of pollutants from soil by vapor extraction through perforated vertical heater wells inserted in the soil. The vertical heater wells to heat the soil to elevated temperatures by thermal conduction are used with sheeting on the soil surface to reduce the short-circuiting effects of vapor extraction. Soil contaminants are removed by vaporization, in-situ thermal decomposition, oxidation, combustion, and by steam stripping.

U.S. Pat. No. 5,114,497 discloses a method of remediation comprising supplying thermal energy to the soil at one or more locations under the surface of the soil through a relatively flat and flexible heat source located between the surface of the soil and an insulative cover material. The vapors resulting from contaminant vaporization or decomposition under the influence of thermal energy are then collected under the influence of reduced pressure.

U.S. Pat. No. 5,169,263 discloses a similar in-situ heating process which utilizes an in-situ vapor recovery system comprising perforated or slotted pipes buried in the soil below the depth of contamination. A vapor extraction and treatment system is connected to the pipes, and heat is supplied to the soil surface by a relatively flat and flexible resistance heater.

U.S. Pat. No. 5,193,934 discloses another in-situ desorption system which utilizes a perforated or slotted pipe buried in the soil below the depth of contamination in the soil, with a vapor extraction and treatment system. The source of heating comprises of fuel and compressed air fed to a pressurized combustion chamber (located on the surface of the earth) and combusted, the combustion products flow into the in-situ pipe and distributed through the contaminated soil. The contaminants and their by-products are displaced by the combustion products into the vapor treatment system.

U.S. Pat. No. 5,011,329 discloses an in-situ method and apparatus for injecting hot gas into boreholes formed in a polluted soil area to vaporize the soil and pollutants, and for collecting the resultant off gas of pollutants above ground. A burner heats pressurized gases and mixes the same with combustion gases for delivery into the polluted soil via in-situ injection.

European Patent Applications EP10447027 and EP10447028 and U.S. Pat. No. 7,618,215 disclose methods and apparatuses for soil remediation using heater composed of a gas burner having its burner nozzle and burner end located above the surface of the ground and polluted zone, said burner nozzle and burner end placed in a tube portion that extends into the ground and polluted zone. The hot combusted gases are forced down the entirety of the tube portion, transferring heat by conduction vertically down the tube, first at the tube's upper portion and finally reaching the tube's lower portion. An extraction tube transfers off gases to the gas burner, where they are combusted as supplemental fuel. Means of re-using heat energy from the primary heater in a separate, second heater are disclosed.

While the stated methods, apparatuses and techniques may prove effective in providing in-situ decontamination of the soil in certain and limited situations, these methods, apparatuses and techniques generally necessitate costly operating and energy inputs, require expensive equipment, provide inefficient heat transfer to pollutants or soil, or require elaborate vapor extraction and treatment systems.

The need exists for a cost-effective, improved and efficient in-situ technique for the removal of pollutants from the subsurface soil and groundwater. A more energy efficient technique of delivering heat to the polluted soil and groundwater is needed, such that the pollutants are quickly and effectively mobilized and removed. Also, the use of propane or natural gas to produce the heat of combustion is needed at sites where large supplies of electricity are not readily available. Just as importantly, the delivery of that heat to the polluted zone in a manner that minimizes heat loss in unpolluted zones is needed. To minimize equipment requirements, a technique that oxidizes extracted pollutant off gas in one or several heaters is needed.

A thermal conductive heating and desorption system is disclosed, providing superior results to other systems for the removal of pollutants from soil, groundwater and other affected medias using a novel enhanced gas fired recuperative heater and oxidation system. Pollutants in the affected, heated media are partially destroyed by hydrolysis, pyrolysis and/or oxidation processes. Remaining pollutants are extracted from the affected media, and pollutant off gas is then introduced into the heater system where it is both thermally and catalytically oxidized. Heat from combusted fuel and pollutant off gas in the heater system is used to preheat incoming combustion air through a recuperative heat exchanger, enabling significant reductions in fuel usage by the heater system. Combusted fuel and off gas discharged from the heater system may be further treated to achieve specified discharge standards.

### SUMMARY

Methods of accomplishing the same are similarly provided, for efficiently remediating polluted media by optimizing thermal conductive heating temperatures and off gas extraction rates and treatment to achieve compliance with changing environmental regulations. According to a feature of the present disclosure, a system for thermally treating affected media is disclosed comprising, in combination: a gas fired heater having both an inner and outer passage, a burner module having a recuperative heat exchanger, an exhaust passage, a catalytic surface area, a differential pressure source, and an off gas extraction point.

According to another feature, a burner module is disclosed comprising, in combination: a differential pressure source, a gas inlet, a gas passage, a combustion air inlet, a combustion air passage, a combustion air/gas mixer, a burner nozzle, an igniter, a combusted gas passage, and an exhaust outlet.

According to another feature, the heater is placed vertically, horizontally or at a slant angle into polluted soil. Gas and combustion air are supplied to the burner module and are carried via their respective passages to the combustion air/gas mixer where the gas and combustion air are mixed to produce a flame that is directed through the burner nozzle and further down the inner passage (combusted gas passage). Combusted gases discharged from the bottom end of the heater's inner passage strike the closed end of the outer passage and flow reversely through the outer passage (exhaust passage) in order to further transfer heat uniformly through the heater, and to preheat the combustion air flowing toward the burner end. Combusted gases remain enclosed in the heater. Combusted air exits the heater through the burner's exhaust passage and exhaust outlet. Heat produced by the heater is transferred by means of conduction, radiation, convection and advection to the polluted media.

Further, off gas may be extracted from one or several points from the polluted media, such as through soil vapor extraction or multi-phase extraction wells. One or more differential pressure sources may apply vacuum to these off gas extraction points, and the extracted off gas is then directed to the burner through the combustion air inlet. The off gas is both thermally and catalytically oxidized within the heater system. First, the burner thermally oxidizes this incoming off gas at the burner end and further thermal oxidation occurs in the heater due to the heater's features enabling increased residency time. Second, a catalytic surface area in the outer passage of the heater reacts with any remaining pollutants in the off gas to further catalytically oxidize said pollutants. Alternatively, pollutant off gases that are problematic to destroy via oxidation (i.e., chlorinated solvents), may be directed instead to an aboveground vapor treatment module (i.e., granular activated carbon or condensation treatment).

As used in the present disclosure, the term “off gas” shall be defined as gasses extracted from at least one source of off gas, including but not limited to vapors to-be-removed during the course of soil or groundwater remediation activities and byproduct gases from the decomposition of pollutants. As used in the present disclosure, the term “pollutant” shall be defined as any volatile organic compound, semi volatile organic compound, polycyclic aromatic hydrocarbons, pesticides, herbicides, tars, polychlorinated biphenyls, mercury, dioxins, residue of explosives, heavy hydrocarbons, and other pollutants as known to artisans. As used in the present disclosure, “soil vapor extraction” (SVE), also known as soil venting or vacuum extraction, is a method that applied a vacuum to one or more extraction points near the source of pollutant(s) in the soil. Volatile constituents of the contaminant mass evaporate and the vapors are drawn toward and extracted through the extraction points.

Prior technologies often rely on the use of electrical inputs for the heating of soils, groundwater and affected media via thermal conduction. Artisans will appreciate the features of the present disclosure that are tailored to reduce energy consumption compared to the prior art. Propane or natural gas is the primary source of energy for the heaters. Propane and natural gas are generally considered “clean energy” sources, and as such, do not require the purchase of carbon credits or clean energy credits to meet the clean energy goals set forth by the United States Environmental Protection Agency and other regulatory bodies. The use of the recuperative heat exchanger in the present disclosure efficiently preheats air to-be-combusted, thereby reducing the energy input required to attain a given combusted gas temperature, and further reducing byproduct gas emissions.

Prior technologies also rely on the combustion of fuel/gas and air at a location above the level of the ground or above the zone of pollutants to be remediated. Such an approach requires an additional energy to both transfer the heat of combustion to the desired treatment zone and to compensate for heat loss into undesired zones (i.e. the top portions of the heating device). Artisans will appreciate the present disclosure's placement of the burner's mixer/nozzle nearer to, or in, the desired treatment zone. Artisans will similarly appreciate that the upwardly mobile convective heat from combustion is utilized to preheat the combustion air traveling downward through the heater's recuperative heat exchange system.

### BRIEF DESCRIPTION OF THE DRAWINGS

FIG. 1 is an illustration of an embodiment of a soil and groundwater remediation system according to the present invention.

FIG. 2 is an illustration of another embodiment of a soil and groundwater remediation system according to the present invention.

FIG. 3 is an illustration of another embodiment of a soil and groundwater remediation system according to the present invention.

FIG. 4 is a two-dimensional cross-sectional view of an embodiment of an advanced thermal conductive heater system that is used in a soil and groundwater remediation system according to the present invention.

FIG. 5 is a three-dimensional cross-sectional view of an embodiment of an advanced thermal conductive heater system that is used in a soil and groundwater remediation system according to the present invention.

FIG. 6 is another two-dimensional cross-sectional view of an embodiment of an advanced thermal conductive heater system that is used in a soil and groundwater remediation system according to the present invention.

FIG. 7 is a two-dimensional cross-sectional view of another embodiment of an advanced thermal conductive heater system that is used in a soil and groundwater remediation system according to the present invention.

FIG. 8 is a three-dimensional cross-sectional view of the same embodiment of an advanced thermal conductive heater system that is used in a soil and groundwater remediation system according to the present invention.

FIG. 9 is another two-dimensional cross-sectional view the same embodiment of an advanced thermal conductive heater system that is used in a soil and groundwater remediation system according to the present invention.

FIG. 10 is a top-looking view of an embodiment of a complimentary pattern of heater wells and extraction wells that is used in a soil and groundwater remediation system according to the present invention.

FIG. 11 is a top-looking view of an embodiment of a hexagonal pattern of heater wells and extraction wells that is used in a soil and groundwater remediation system according to the present invention.

### DESCRIPTION OF THE PREFERRED EMBODIMENT

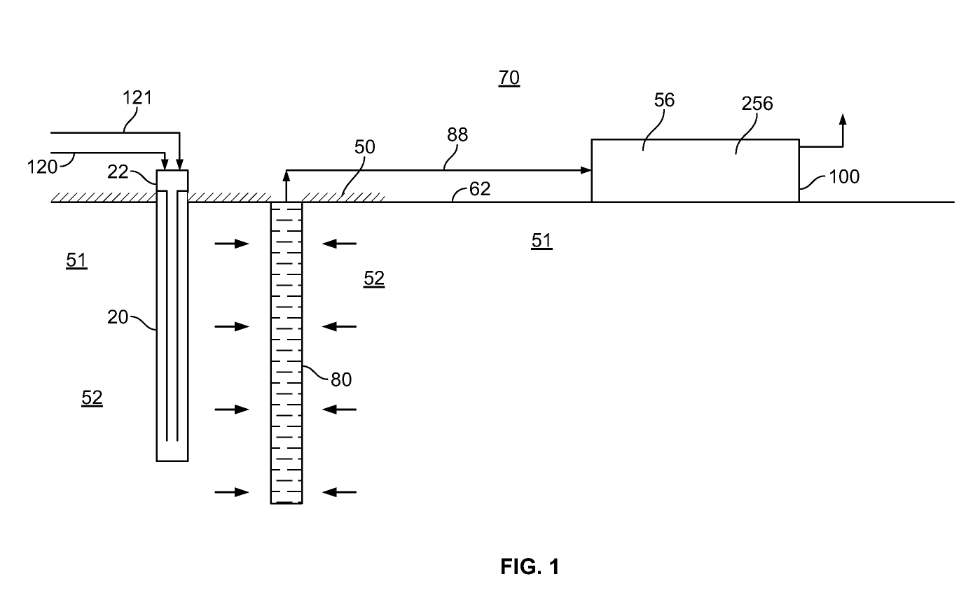

FIGS. 1, 2 and 3 show a generalized schematic of the invention. Briefly, in the disclosed apparatus and method pollutants are thermally desorbed from the polluted soil zone by direct heating of the polluted soil and/or groundwater zone. The heat is generated by combustion of fuel with air within a heater placed at or near the polluted zone. Traditional soil vapor extraction wells or techniques may be utilized to collect the off gas generated as a result of the heating of the polluted zone. Off gases may be directed to the heater for thermal and catalytic oxidization or sent to a traditional off gas treatment system.

The apparatus of the claimed invention is schematically depicted in FIGS. 1, 2 and 3. The basic components of this invention are: (1) a heater well 20 containing a heater tube module 21 and burner module 22; (2) off gas barriers 50 which enclose the surface of the soil or polluted zone 52 and which prevent the vertical flow of heat and vaporized off gases from polluted zone 52 and also prevents air flow into the polluted zone 52 from the atmosphere 70 through the soil surface 62; (3) extraction wells 80; (4) off gas extraction and treatment module 100, and (5) natural gas, propane or other fuel (e.g., methane) supply and air or other oxygen supply is connected by lines 120 and 121, respectively, to the burner module 22.

Turning to FIGS. 1, 2 and 3, and focusing on heater well 20, the exterior region around it which borders the unpolluted zone 51 is packed or filled with a material with relatively poor heat conduction properties, such as refractory cement or mortar. The exterior region around heater well 20 which borders the polluted zone 52 is packed or filled with a material with relatively good heat conduction properties, such as soil mixed with steel shot or bauxite. The exact fill materials and fill area may be any combination as known by artisans.

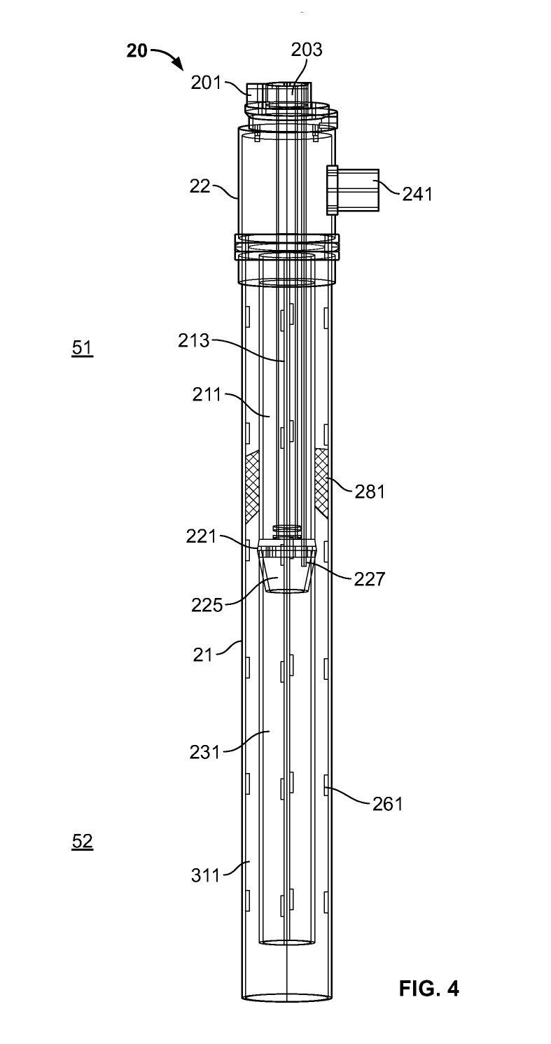

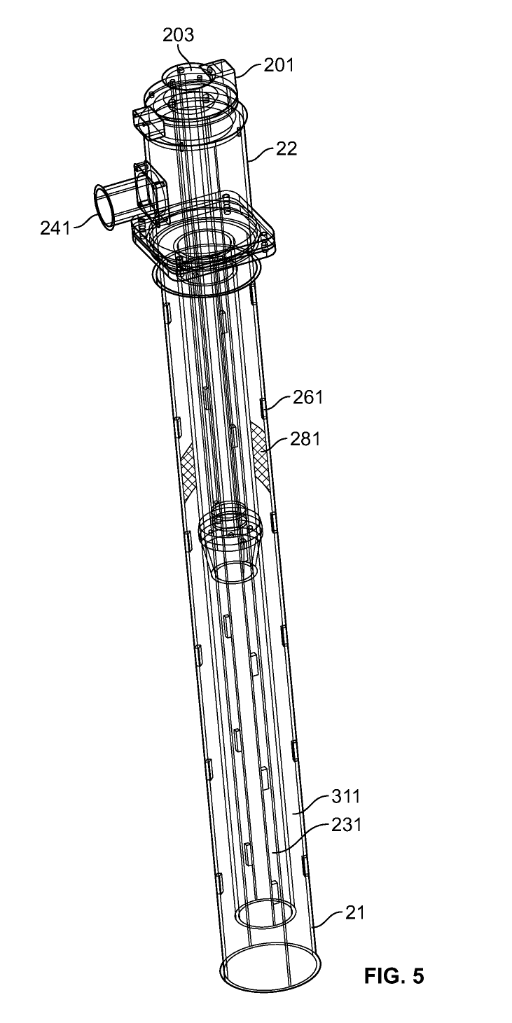

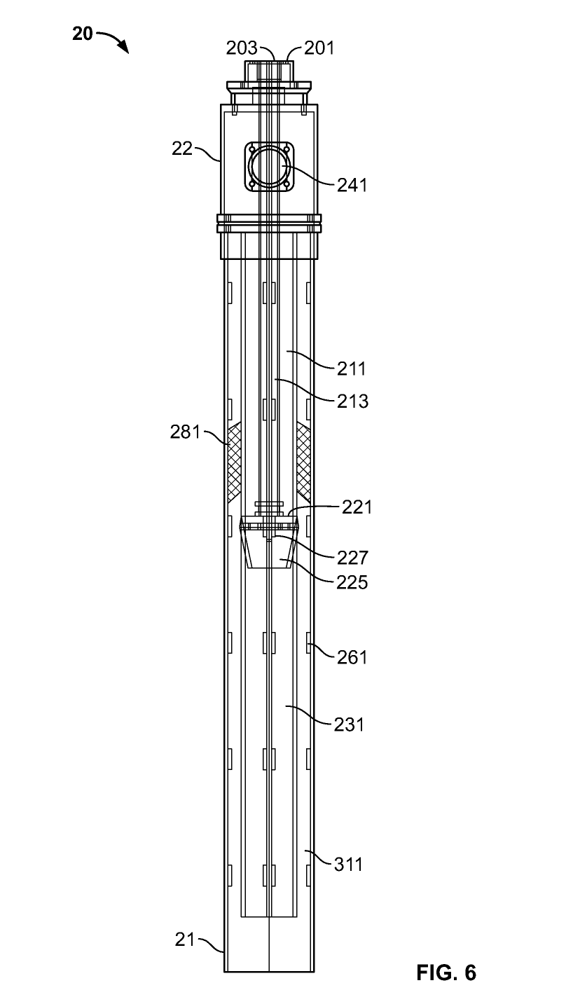

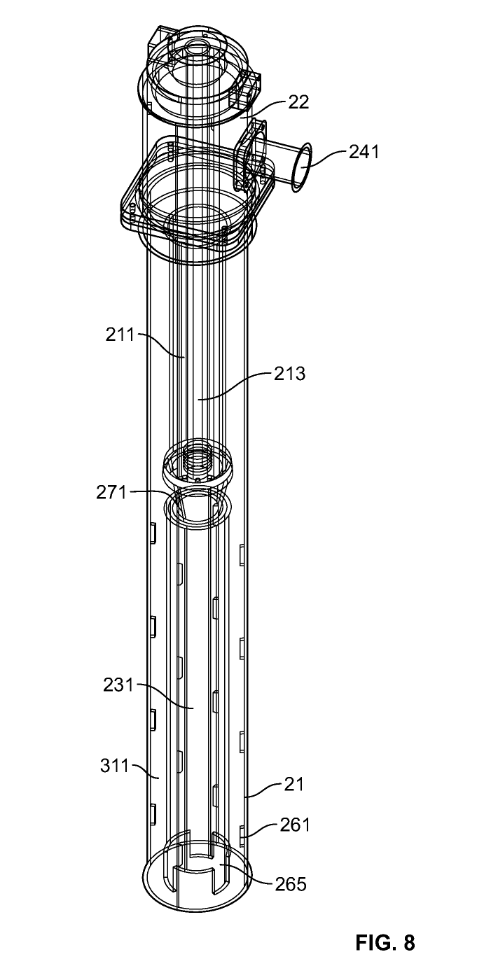

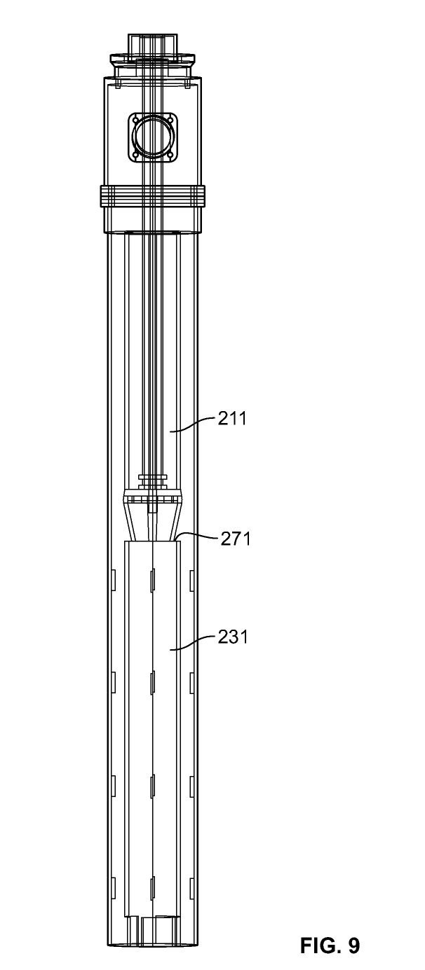

Turning to FIGS. 4, 5, 6, 7, 8 and 9, air or oxygen lines 121 and fuel or gas lines 120 are routed to the heater well 20 and connect to the burner module 22 so that air or oxygen enters via combustion air inlet 201 and fuel or gas enters via gas inlet 203. Combustion air and fuel are neither mixed nor ignited above the grade of soil or media into which the heater well 20 is inserted. Instead, the combustion air and fuel travel down the heater well 20 through their respective passages 211 and 213. A differential pressure source 256 produces positive pressure to force combustion air down combustion air passage 211. Differential pressure source 256 may be fitted with regulators or variable drives to control the flow and pressure exerted upon the combustion air, as would be known to artisans. Differential pressure source 256 may be comprised of the same equipment as off gas extraction and treatment module 100 and vacuum module 56. Gas delivered under pressure to gas inlet 203 travels down heater well 20 through gas passage 213, and gas regulators and orifices may be used to control the flow and pressure of gas, as would be known to artisans.

Gas passage 213 terminates into combustion air/gas mixer 221, where the gas is released under pressure to mix with preheated combustion air at a location just above or within burner nozzle 225. To begin the combustion of this air/gas mixture, igniter 227 provides a source of ignition. After a predetermined temperature is reached inside the heater well 20, the igniter may be turned off, and the temperature of the preheated air mixing the gas is sufficient to combust the mixture thoroughly. Alternating cycles of on/off firing, modulated firing or pulsated firing may be accomplished in heater well 20, as would be known to artisans.

Depending on the particular fuel and air inputs into heater module 22, temperatures ranging from 200° to 1,200° C. may be generated within the heater well 20 so as to develop a sufficient heat flux transfer into the polluted zone 52 surrounding the heater well 20, causing the pollutants to be mobilized.

The combusted gases exiting burner nozzle 225 travel further downward through combusted air passage 231. The heat of the combusted gases is transmitted downwardly and laterally by the processes of radiation and conduction. Some heat is also transferred vertically upwards. Combusted gases discharged from the bottom opening of the combusted air passage strike the closed, bottom end of the heater well 20, and flow reversely (upwardly) through the heater well's exhaust passage 311 and further transfer heat uniformly and evenly through both the heater well 20 and the polluted zone 52.

The flow of hot combusted gases through the exhaust passage 311 transfers some heat (via conduction and radiation) to the walls of combustion air passage 211, which it contacts. This heat transfer preheats the combustion air flowing downward through combustion air passage 211 and cools the combusted air flowing upward through exhaust passage 311.

Combusted air exits the heater through the burner module's exhaust outlet 241. Combusted air may be discharged to atmosphere, further treated to reduce byproduct gases if necessary, used to heat or preheat other media, or otherwise used as known by artisans.

In one preferred embodiment, set forth in FIGS. 4, 5 and 6, combustion air passage 211 and combusted air passage 231 are of identical or similar outer and inner dimensions, and said passages are welded or otherwise affixed to form a contiguous passage. Stabilizers 261 are affixed to the outer portion of combustion air passage 211 and combusted air passage 231, and stabilizers 261 fit against the outer wall of exhaust passage 311. Stabilizers 261 have at least two purposes: they center the passages 211 and 2xx within heater well 20 and they transmit heat via conduction outwardly to the extremities of heater well 20.

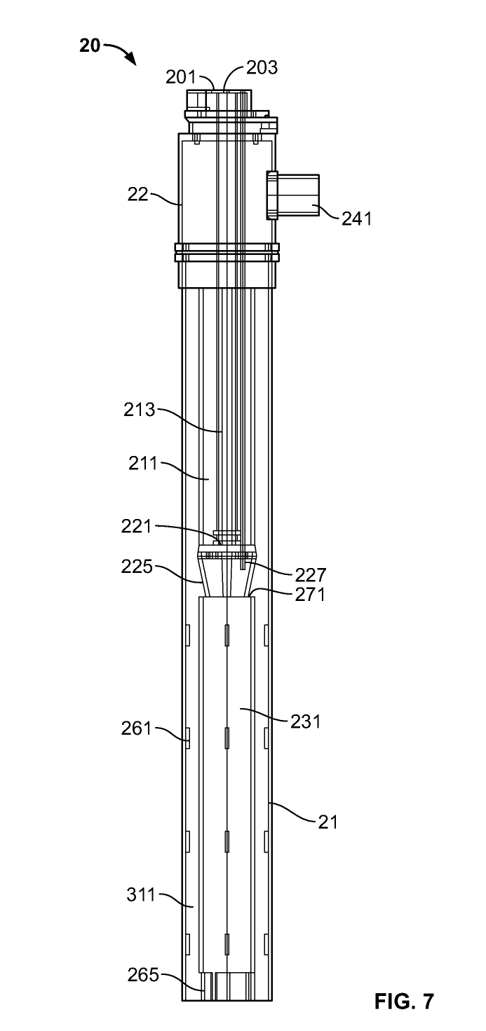

In another preferred embodiment, as set forth in FIGS. 7, 8 and 9, combustion air passage 211 and combusted air passage 231 are of identical or similar outer and inner dimensions, but said passages do not form a contiguous passage, instead forming a recuperative aperture 271 between combustion air passage 211 and combusted air passage 231. Combusted air passage 231 has supporting legs 265 to support its weight inside heater tube module 21, and allow hot combusted air to exit combusted air passage 231 for entry into exhaust passage 311. Combusted air passage 231 also utilizes stabilizers 261 to center it inside heater tube module 21. Combusted air leaving burner nozzle 225 and combustion air passage 211 travels downward into combusted air passage 231, effectively crossing through the plane of recuperative aperture 271. A portion of hot exhaust gases traveling upwards through exhaust passage 311 are induced by draft and pressure forces into and through recuperative aperture 271, and are re-introduced to combusted air passage 231. This re-introduction of hot exhaust gases recuperates a portion of heat energy from the gases to-be-exhausted and reduces the fuel/gas and air/oxygen inputs required to achieve or maintain a given temperature.

In another embodiment, turning now to FIGS. 1, 2 and 3, extraction wells 80 are comprised of well-casings 82 having perforations 84, some of which are located within the polluted zone 52. Extraction wells 80 are attached to vacuum module 56 such as vacuum pump or air compressor that provides sufficient negative pressure to achieve the desired vacuum, flow and radius of influence in the polluted zone 52, as known by artisans, such that mobilized pollutants and off gas are pulled into the extraction wells 80. Vacuum module 56 may be the same equipment or infrastructure as differential pressure source 256. Well-casings 82 may be constructed of stainless or mild steel material or other material known to artisans.

In one embodiment, as viewed in FIG. 1, off gas extracted from extraction wells 80 is directed to an above-ground off gas extraction and treatment module 100 for treatment prior to discharge from the system. Off gas extraction and treatment module 100 may be comprised of one or several commercially-available systems such as those using granular activated carbon, catalytic oxidizers, thermal oxidizers, C3 Technology, condensation recovery or other technologies as known to artisans. The option of utilizing off gas extraction and treatment module 100 is dependent upon several factors, including the characteristics of the off gas to-be-treated including its: constituents, concentration, temperature, relative humidity, pH, salt content, flow and vacuum.

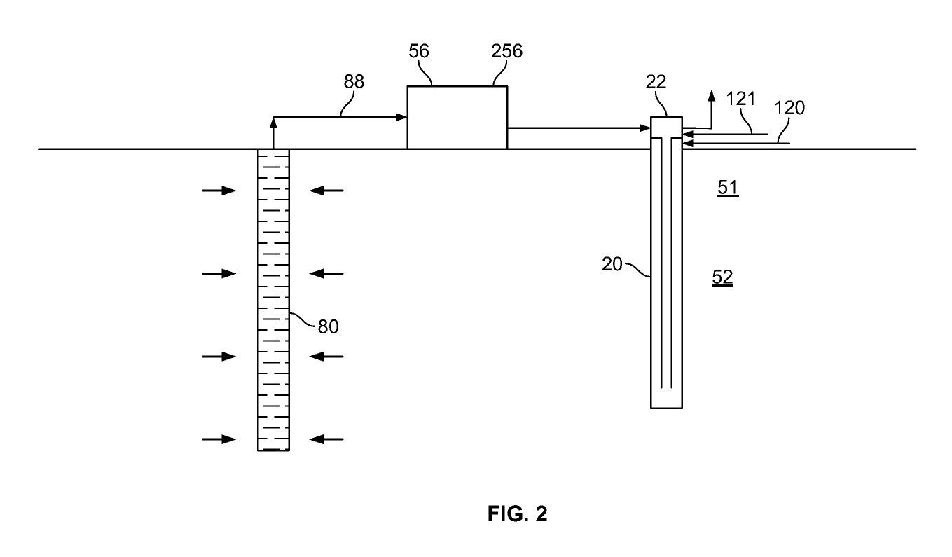

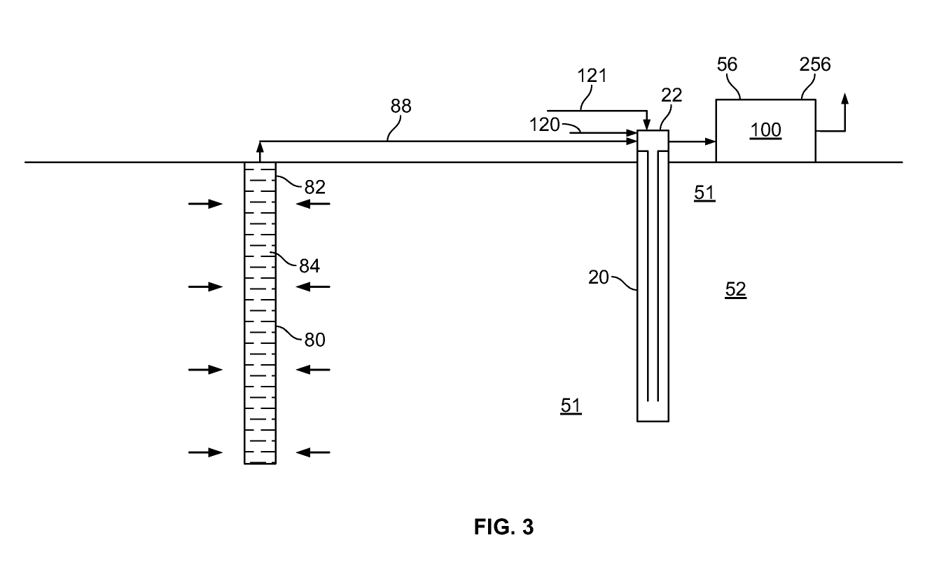

In the preferred embodiment, as viewed in FIGS. 2 and 3, all or a portion of the off gas extracted from extraction wells 80 is directed to one or several heater wells 20 for thermal and catalytic destruction inside said heater wells 20. The off gas is sent via air or oxygen lines 120 to heater wells 20. Prior to entering heater wells 20, this off gas may be introduced or mixed with other air or oxygen in lines 120. Off gas or a mixture of off gas and air or oxygen enters heater module 22 through air inlet 201. Off gas is first thermally destroyed by the increased temperature achieved in air passage 211.

Thermal destruction is dually facilitated by the combustion in and around burner nozzle 225 and through the combusted air passage 231.

As depicted in FIGS. 4, 5 and 6, catalytic combustion of any remaining off gas of pollutants is achieved by the hot combusted air and off gas air contacting catalytic material 281, which is placed in one or several of combusted air passage 231 and/or exhaust passage 311. Catalytic material 281 may be composed of one or several commercially-available catalysts such as a monolithic catalyst, ceramic substrate, alumina, precious metals, platinum, palladium, rhodium or other materials as known by artisans. The catalytic material 281 is placed at a location in heater well 20 where fluid and off gas temperatures are preferably between 200° and 600° to maximize catalytic oxidation and prevent against sintering of material caused by excess heat flux into the catalyst. As those skilled in the art will appreciate, catalytic material 281 may similarly be placed outside of heater well 20, such as at a location after exhaust outlet 241. Such a placement of catalyst material 2xx outside of heater wells 20 may be necessary to maintain optimum temperatures for catalytic oxidation of certain off gases, and may facilitate easier catalyst material replacements.

Off gas and exhausts exhausted from heater wells 20, having been thermally and catalytically treated, may at times require further treating by off gas extraction and treatment module 100 in order to meet stringent regulatory requirements, as seen in FIG. 3. In this instance, artisans will appreciate that the conditioning and treatment of those off gases in heater wells 20 will reduce the complexity and cost of final off gas treatment in off gas extraction and treatment module 100.

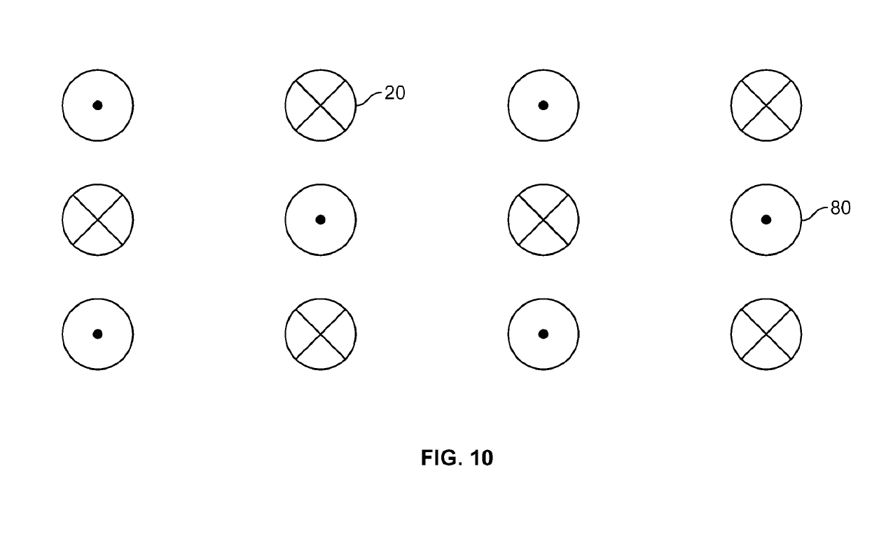

Turning to FIG. 10, heater wells 20 and extraction wells 80 may be arranged in complimentary patterns in one preferred embodiment.

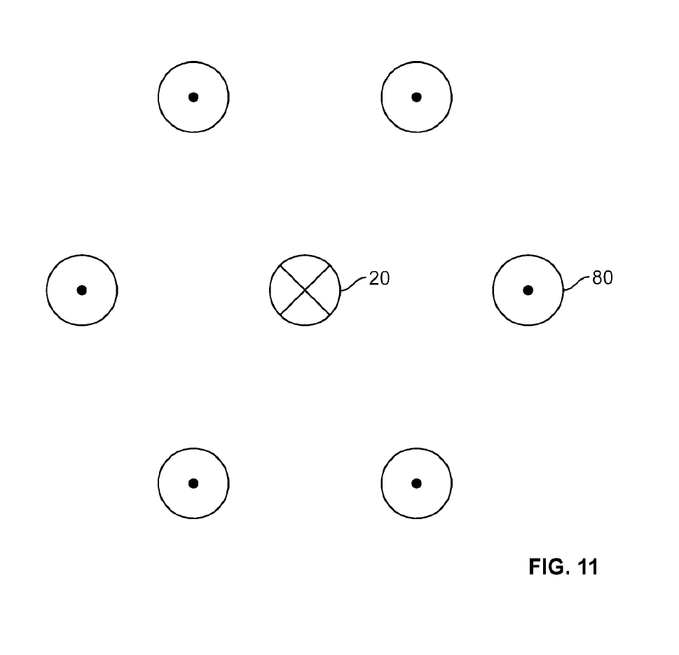

Turning to FIG. 11, heater wells 20 and extraction wells 80 may be arranged in hexagonal patterns in another preferred embodiment. Other patterns and arrangements are common in soil vapor extraction and in-situ treatment techniques and may be utilized as known by artisans.

While the method and apparatus have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

What is claimed is:

1. A heater assembly comprising, in combination:
at least a heater well containing a heater tube module and a burner module,
a fuel inlet connected to said heater well for feeding fuel to said burner module,
an air inlet connected to said burner module for feeding air to said burner module through a combustion air passage and mixing with said fuel in a fuel-air mixer,
an exhaust passage for receiving hot exhaust gases from said burner module, said exhaust passage operatively positioned adjacent and cooperating with said combustion air passage for heating the air in said combustion air passage before said air reaches a burner nozzle, and means for shielding said fuel means from overheating, said combustion air passage and said exhaust passage together defining a single-ended recuperative heat exchange mechanism inside said heater well.

2. The heater assembly of claim 1, further comprising:
a source of off-gas of at least one pollutant, said pollutant off-gas being introduced into the heater assembly for use as a supplemental fuel, and
a catalytic material disposed within said heater assembly, wherein said catalytic material accelerates the oxidation of the pollutant off-gas.

3. The heater assembly of claim 1, further comprising:
a source of off-gas of at least one pollutant, said pollutant off-gas being introduced into the heater assembly for purposes of destroying said pollutant off-gas; and,
a catalytic material disposed within said heater assembly, wherein said catalytic material accelerates the oxidation of the pollutant off-gas.

4. The heater assembly of claim 1, further comprising:
a series of non-converging stabilizers affixed in a generally vertical manner to the outer portion of the air passage, said stabilizers fitting in close proximity to the outer portion of the exhaust passage, and whereby said stabilizers transmit heat via conduction outwardly to the walls of the heater well.

5. The heater assembly of claim 1, further comprising:
a combustion air passage and combusted air passage in communication with one another as a single passage, so that no apertures are formed except at the topmost and bottommost section of said passage.

6. The heater assembly of claim 1, further comprising:
a combustion air passage and combusted air passage in communication with one another as related passages, characterized by at least one recuperative aperture between said combustion air passage and said combusted air passage.

7. The heater assembly of claim 1, wherein:
the means for shielding the fuel from overheating comprises placement of the fuel passage inside the annular space of the combustion air passage.

8. A thermal soil remediation system for removing contaminants from soil, comprising:
a plurality of heater assemblies positioned in soil,
a plurality of vacuum wells positioned in soil,
wherein the soil is heated by at least one of the heater assemblies,
wherein the source of energy for heating the soil is comprised of at least one of:
a gaseous fuel, or
a liquid fuel, and
wherein heated off-gas is removed from the soil through at least one of the vacuum wells.

9. The system of claim 8, further comprising:
a heater assembly wherein an exhaust gas from the heater assembly's exhaust passage is used to heat combustion air prior to combustion in the heater assembly, and the combustion air into the heater assembly is used to cool the exhaust gas from the heater assembly's exhaust passage.

10. The system of claim 8, further comprising:
a heater assembly wherein at least a portion of the off-gas extracted by at least one vacuum well is oxidized.

11. system of claim 8, further wherein:
at least one heater assembly is positioned substantially horizontally into the soil.

12. A system for the remediation of contaminated soil comprising:
heating means penetrating the ground surface of the soil, wherein said heating means comprises an heater assembly connected to a source of gaseous or liquid fuel, which supplies energy to said heating means;
insulation means covering at least one portion of said contaminated soil;
heat transfer means for transferring heat from said heating means to one or more locations below the surface of the soil, wherein said heat transfer means comprises one or more soil-free vertical passages extending downwardly from the surface of the soil;
vapor collection means for collecting, at reduced pressure and beneath the surface of the soil, the vapors generated by said heating means, wherein said vapor collection means comprises soil-free vertical passages extending upwardly through the soil from below the surface of the soil; and,
separation means to remove from the collected vapors the environmentally undesirable components thereof.

13. The system of claim 12, further wherein:
the contaminated soil is heated to an average temperature below the boiling point of water.

14. The system of claim 12, further wherein:
at least one portion of the contaminated soil is heated to a temperature above the boiling point of water.

15. The system of claim 12, further wherein:
at least one of the contaminants remediated from said soil is of an organic composition.

16. The system of claim 12, further wherein:
at least one of the contaminants remediated from said soil is of an inorganic composition.

17. The system of claim 12, further wherein:
at least one of the contaminants remediated from said soil is a metal.

18. An improved heater assembly, which comprises:
a heater well containing a heater tube module and a burner module,
a fuel inlet connected to said heater well for feeding fuel to said burner module,
an air inlet connected to said burner module for feeding air to said burner module through a combustion air passage and mixing with said fuel in a fuel-air mixer,
an exhaust passage for receiving hot exhaust gases from said burner module, said exhaust passage operatively positioned adjacent and cooperating with said combustion air passage for heating the air in said combustion air passage before said air reaches a burner nozzle, and means for shielding said fuel means from overheating, said combustion air passage and said exhaust passage together defining a single-ended recuperative heat exchange mechanism inside said heater well.
